(19) United States
(12) Patent Application Publication
(10) Pub. No.: US 2008/0209231 A1
(43) Pub. Date: Aug. 28, 2008

(54) Contents Encryption Method, System and Method for Providing Contents Through Network Using the Encryption Method

(75) Inventors: Mun-Churl Kim, Daejeon-City (KR); Keun-Soo Park, Seoul (KR); Beom-Goo Lee, Seoul (KR)

Correspondence Address: GIFFORD, KRASS, SPRINKLE,ANDERSON & CITKOWSKI, P.C, PO BOX 7021, TROY, MI, 48007-7021, US

(73) Assignees: Information and Communications University Research and Industrial Cooperation Group, Daejeon-City (KR); Korean Broadcasting System, Seoul (KR)

(21) Appl. No.: 11/577,125

(22) PCT Filed: Oct. 12, 2005
(86) PCT No.: PCT/KR2005/003398

§ 371 Date: Apr. 12, 2007

(30) Foreign Application Priority Data
Oct. 12, 2004 (KR) 1020040081536

(51) Int. Cl. G06F 12/14; H04L 9/00

(52) U.S. Cl. 713/189

(57) ABSTRACT

Disclosed are a contents encryption method, and a system and method for providing contents through a network using the contents encryption method. In order to provide contents through the network more securely, at least one piece of contents and corresponding metadata are recursively multi-encrypted at least once, and encrypted data are then provided. In particular, encrypted positions of the contents and corresponding decryption information are expressed as metadata, and the metadata include parameter information on respective encryption tools used for multi-encryption, an order of the applied encryption tools, positions of the encryption tools, and a list of encryption tool substitutes. The metadata are provided when the contents are provided. Therefore, the contents provider and receiver can more safely and systematically manage the metadata including contents decryption information, and multimedia are efficiently protected, managed, and controlled.

### TECHNICAL FIELD

The present invention relates to a contents providing system and method. More specifically, the present invention relates to a contents encryption method, and a system and method for stably providing contents through a network using the encryption method.

### BACKGROUND ART

Various types of contents have been propagated through networks as new network technologies have been developed. The contents provided through the network can be easily copied and delivered, and hence it is substantially difficult to protect the copyrights of those contents. For the purpose of protecting the copyrights, many methods have been used such as a watermarking scheme for determining falsehood of contents by inserting an invisible image into the contents, and a scheme for encrypting contents, distributing the contents, and transmitting a decryption key only to granted users so that they may use the contents.

In the conventional case of encrypting and transmitting contents, part or all of digital contents have been encrypted, the encrypted contents have been transmitted, and a receiver has decrypted the contents by using an encryption key and has used them. For example, in the case of transmitting the contents A, both the contents A and metadata (mainly text-based XML data) to which information used for encrypting the contents A have been encrypted have been transmitted.

The conventional method represents a method for protecting the contents by encrypting digital data in a simple manner, but it fails to propose a systematical scheme for multi-encryption of contents and metadata, and it also fails to systematically present information on application of encryption.

When the information on application of encryption is not presented systematically, it may take a long time for the receiver having usage rights to decrypt the encrypted contents, and the receiver may not be able to use the contents normally if the contents could not be completely decrypted, depending on the case.

### DISCLOSURE

### Technical Problem

It is an advantage of the present invention to recursively encrypt at least one of digital contents and corresponding metadata to thus protect and manage the contents in a more secure manner.

It is another advantage of the present invention to systematically realize encryption information on the recursively encrypted contents into the metadata, and thus efficiently manage and use the encrypted contents.

It is still another advantage of the present invention to provide the recursively encrypted contents and the metadata for systematically showing encryption information through the network, and thus control stable and efficient usage of contents.

### Technical Solution

In one aspect of the present invention, a method for encrypting contents includes: encrypting the contents according to a first encryption scheme, and generating first encryption metadata including information on the performance of encrypting to thus perform a first encryption stage; encrypting the contents that are encrypted in the previous stage and corresponding metadata according to an established encryption scheme, and generating second encryption metadata including information on the performance of encrypting to thus perform a second encryption stage; and performing the second encryption stage as many as an established number of times and generating final encryption contents and final encryption metadata to thus perform a final stage.

In another aspect of the present invention, a system for providing contents to a user terminal includes: a contents encryptor for encrypting, storing, and managing contents, and generating, storing, and managing encryption metadata according to the encryption; a user interface for receiving contents service request data from the user terminal; and a contents transmitter for processing the encrypted contents that are provided by the contents encryptor and that correspond to the contents service request data, and encryption metadata corresponding to the contents, into transmittable contents information, and transmitting the contents information to the user terminal. The contents encryptor encrypts the contents according to an established first encryption scheme, performs a first encryption stage for generating first encryption metadata including information on the performance of execution, encrypts the contents encrypted in the previous stage and corresponding metadata according to an established number of encryptions, and performs a second encryption stage for generating second encryption metadata including information on the performance of the encryption at least once.

In still another aspect of the present invention, a method for providing contents in a system for providing contents to a user terminal includes a) the system encrypting the contents, generating encryption metadata based on encryption information used for the encryption, and combining the encrypted contents and the encryption metadata to generate combined contents; b) the system generating copyright metadata based on copyright and usage right information on the contents; c) the system selecting corresponding combined contents according to contents service request data transmitted by the user terminal; d) the system acquiring the selected combined contents and copyright metadata; and e) the system processing the combined contents and metadata to be transmittable contents information, and transmitting the contents information to the user terminal. In this case, a) comprises encrypting the contents according to an established first encryption scheme, performing a first encryption stage for generating first encryption metadata including information on the performance of the encryption, encrypting the contents encrypted in the previous stage and corresponding metadata according to an established second encryption scheme according to an established number of encryptions, and performing a second encryption stage for generating second encryption metadata including information on the performance of the encryption, at least once.

### ADVANTAGEOUS EFFECTS

According to the embodiment of the present invention, at least one of digital contents and contents-protecting metadata including copyright information are recursively encrypted so that the contents are securely provided through a network and so the contents can be securely protected and managed.

Further, while encryption information on the encrypted contents is systematically realized in the metadata, a tree structure including at least one of parameter information on applied encryption tools, an encryption application order, positions of encryption tools, encryption tool substitutes, digital signature information on the contents for protecting metadata, binary encryption tools, and contents copyright information, is disclosed. As a result, the encrypted contents are efficiently used, and in particular, the encrypted contents are quickly decrypted.

### DESCRIPTION OF DRAWINGS

FIG. 1 shows a schematic diagram of a contents providing system according to an embodiment of the present invention.

FIG. 2 shows a detailed schematic diagram of a contents encryptor shown in FIG. 1.

FIG. 3 shows a block diagram of a user terminal according to an embodiment of the present invention.

FIG. 4 shows a concept of encrypting contents according to an embodiment of the present invention.

FIG. 5 shows a flowchart of a process for encrypting contents according to an embodiment of the present invention.

FIG. 6 shows a structure of encrypted metadata according to an embodiment of the present invention.

FIG. 7 and FIG. 8 show exemplified encrypted metadata according to an embodiment of the present invention.

FIG. 9 shows a flowchart of a method for providing contents according to an embodiment of the present invention.

### BEST MODE

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

When it is described that a unit includes some components, it means that the unit can further include components in addition to those described unless stated to the contrary.

In addition, the module described in the specification represents a single unit for processing a specific function or an operation, and it can be realized by hardware, software, or a combination of hardware and software.

In the embodiment, at least one piece of contents and corresponding metadata are recursively encrypted at least once so that the contents and the metadata may be provided more securely.

In particular, the metadata are controlled to systematically describe information related to contents encryption. In detail, the metadata are systematically described to include at least one of parameter information on encryption tools applied to contents, an encryption application order, positions of the encryption tools, encryption tool substitutes, binary encryption tools, and contents copyright information, and digital signature information for proving no faultiness of contents protection information.

In order to efficiently decrypt the contents that have a recursive structure and that are encrypted in many folds on the user terminal, the metadata are realized in a tree structure format including a plurality of nodes including contents encryption information. It is controlled to apply an encryption tool to each node forming the tree structure. Therefore, the user terminal can be equipped with a decryption tool before performing encryption based on the metadata.

Also, in order to solve the problem in which it takes much time to encrypt all contents and the user terminal spends much decryption time, part of the contents can be encrypted instead of encrypting all the contents. When the contents are partially encrypted, information on a used encryption tool (algorithm), parameters used for encryption, an encryption key, a key length, and a position in the contents to which encryption is applied is presented as metadata, and the metadata together with the encrypted contents (ciphers) are transmitted to the user terminal, and hence, contents can be distributed in a secure manner. Also, it is allowed to use a plurality of encryption algorithms for a single piece of contents so that the contents are protected in a more secure manner than in the case of partial encryption.

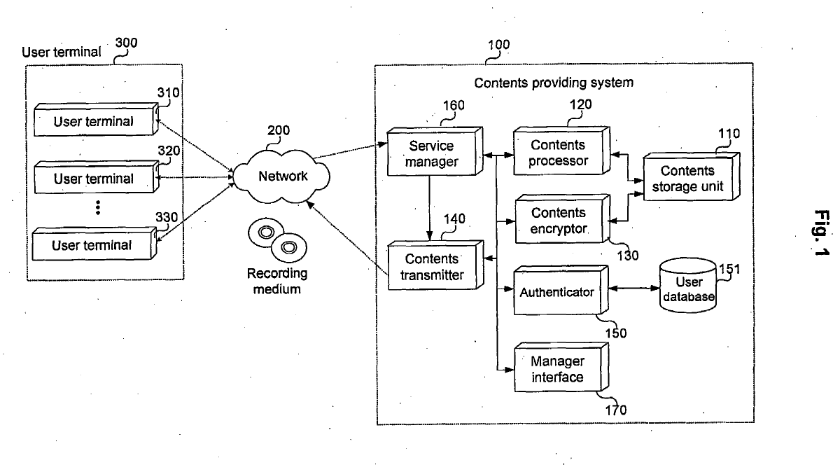

FIG. 1 shows a schematic diagram of a contents providing system according to an embodiment of the present invention, given for the purpose of realizing the contents provision.

The system for providing contents through the network (referred to as a contents providing system hereinafter) 100 is connected to the user terminals (310 to 30N, given as 300 for ease of description) through a network (including wired or wireless networks such as the Internet, wireless communication networks, future networks) 200, as shown in FIG. 1.

The system 100 for providing contents to the user terminal 300 includes a contents storage unit 110 for storing a plurality of contents to be provided, a contents processor 110 for displaying a usage right to the contents to be provided, a contents encryptor 130 for encrypting the processed contents, a contents transmitter 140 for providing the encrypted contents to the user terminal 300 through the network 200, an authenticator 150 for authenticating the user, a service manager 160, and a manager interface 170.

The contents storage unit 110 stores contents provided through various ways such as contents produced by the system 100, contents provided by other systems on the network, and contents provided by users. For ease of management, the contents can be sorted, stored, and managed according to predefined categories.

The service manager 160 analyzes contents service request data provided by the user terminal 300 through the network 200, and operates the contents processor 110, the contents encryptor 130, and the contents transmitter 140 so as to transmit predetermined contents according to analysis results.

The authenticator 150 performs authentication to determine whether the user having requested contents is a user who can receive the contents through the system. For this, the authenticator 150 may include a user database 151 for storing user information. The user database 151 stores information on the users who are registered to the contents providing system 100. For example, the user database 151 stores tendency information such as sex, age, and hobbies together with IDs and passwords corresponding to the identities assigned to the users.

The manager interface 170 establishes copyrights and usage rights on the contents serviced by a manager of the system according to the embodiment of the present invention, or it establishes encryption parameters.

The contents processor 110 generates metadata on the copyright and usage right information for the contents, and in particular, it generates and manages the metadata according to the copyright and usage right performed by the manager interface 170.

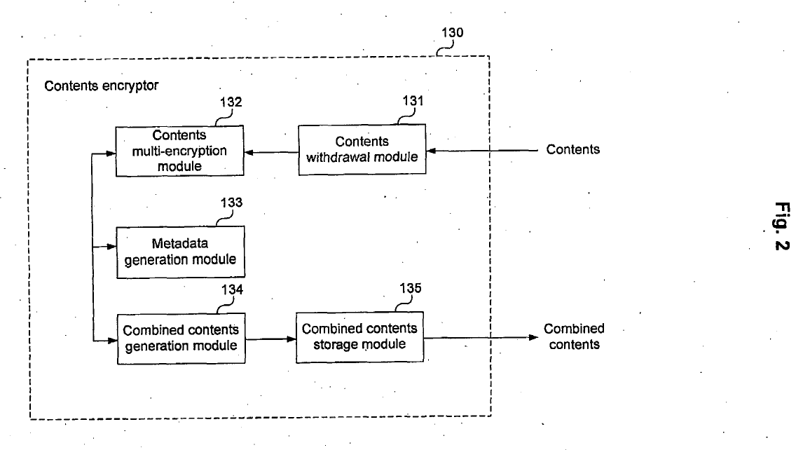

FIG. 2 shows a detailed schematic diagram for the contents encryptor 130 shown in FIG. 1.

The contents encryptor 130 includes a contents withdrawal module 131 for withdrawing contents to be encrypted from the contents storage unit 110, a contents multi-encryption module 132 for encrypting contents in a multiple manner, a metadata generation module 133 for generating encryption metadata on the multi-encrypted contents, a combined contents, generation module 134 for combining the multi-encrypted contents and corresponding encryption metadata into a single unit of combined contents, and a combined contents storage module 135 for storing the combined contents. The combined contents stored in the combined contents storage module 135 can be stored in and managed by the contents storage unit 110.

The contents encryptor 130 performs recursive encryption so as to increase the security of contents. For this, the contents multi-encryption module 132 and the metadata generation module 133 are operated according to an established number of recursive encryptions so that recursive encrypted information may be generated by the number of recursive encryptions. Hence, the contents multi-encryption module 132 performs a first encryption stage for encrypting contents only, and performs a second encryption stage for encrypted contents and corresponding metadata. In this case, the metadata generation module 133 generates metadata having described information related to encryption for each execution of encryption stage. The encryption stage will be described in detail when the operations are described. In the embodiment, the encryption operation by the contents encryptor 130 is controlled by the service manager 160, and without being restricted to this, the encryption operation can be controlled by including an additional control module into the contents encryptor 130.

The user terminal 300 connected through the network is a communication device for supporting receiving of contents from the above-configured system 100, and in detail, it includes wired terminals including a computer that is accessible by cable to the network 200 and an Internet-TV, and wireless terminals including a cellular phone, a PCS, a PDA, an IMT-2000, a PDA phone, and a smart phone that are wirelessly accessible to the network 200.

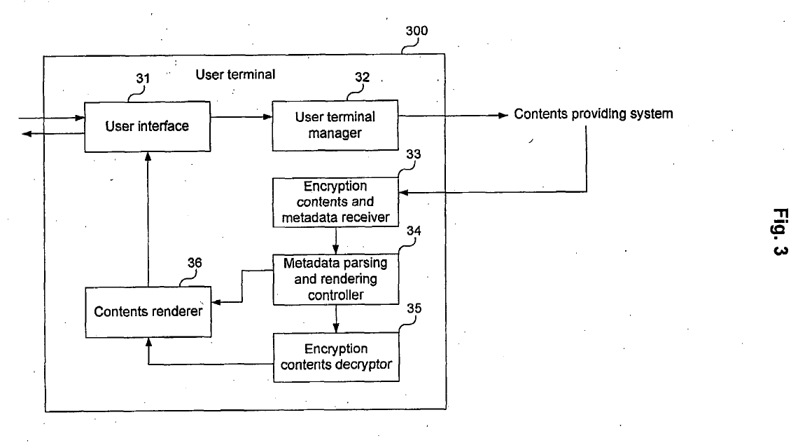

FIG. 3 shows a schematic diagram of the user terminal 300 according to the embodiment of the present invention. As shown in FIG. 3, the user terminal 300 includes a user interface 31, a user terminal manager 32, an encryption contents and metadata receiver 33, a metadata parsing and rendering controller 34, an encryption contents decryptor 35, and a contents renderer 36.

The user interface 31 represents means for controlling the user to request various contents and use the requested contents, and for example, it includes input means such as a keypad and a mouse, and various output means such as a monitor and an LCD.

The user terminal manager 32 generates contents service request data according to the user's contents request provided by the user interface, and transmits the generated data to the system 100.

The encryption contents and metadata receiver 33 receives information from the system 100 according to the contents service request data, and determines and divides encryption contents, encryption metadata, and copyright and usage right metadata, from the received information.

The metadata parsing and rendering controller 34 parses the copyright and usage right metadata, and checks the user's contents copyright and usage right, and parses the encryption metadata when a usage right is assigned to the user (or the user terminal.)

The encryption contents decryptor 35 decrypts the encryption data based on the parsing results of the encryption metadata, and the contents renderer 36 processes the decrypted contents and uses the same or controls the user to check them through the user interface 31. The metadata parsing and rendering controller 34 controls the contents renderer 36 so that the usage right of contents may be applied to the conditions written to the copyright.

An operation of the contents providing system according to the embodiment of the present invention will be described based on the above-described structure.

A method for encrypting contents and generating corresponding encryption metadata will now be described.

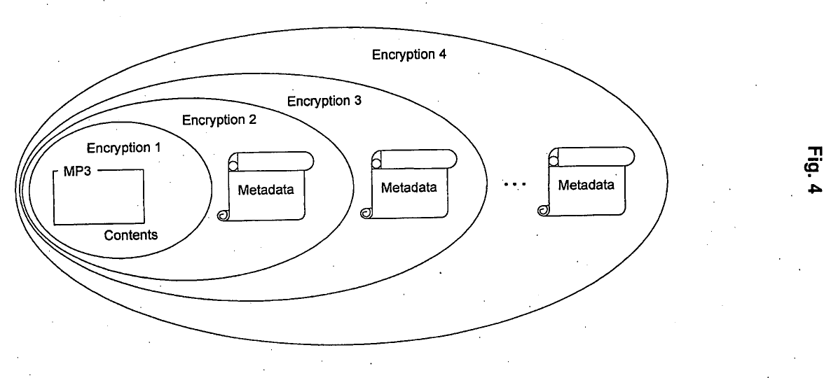

Recursive encryption is performed in order to improve security of the contents provided through the network in the embodiment. FIG. 4 shows an encryption concept according to the embodiment of the present invention.

In the embodiment, recursive encryption is performed in which, as shown in FIG. 4, a piece of contents to be transmitted is encrypted by using a first encryption scheme, and a first encryption stage for generating metadata is performed based on the encryption parameter that is established when the first encryption scheme is used. The first contents and the first metadata encrypted in the first encryption stage are encrypted by using a second encryption scheme, and a second encryption stage for generating second metadata is performed based on the encryption parameter that is established when the second encryption scheme is used. In this instance, the second encryption stage can be performed several times. That is, both the encrypted contents and metadata encrypted in the previous stage are encrypted according to the encryption scheme established in the current stage, and the second encryption stage for newly generating metadata based on the encryption parameter related to the above-noted encryption is performed a plurality of times according to the defined number of recursive encryption. In this instance, the contents are encrypted only according to the established encryption scheme in the first encryption stage, and both the contents and the metadata are encrypted according to the established encryption scheme in the second encryption stage. As a result, as shown in FIG. 4, the original contents to be transmitted and the corresponding metadata are encrypted in a multiple manner. In the final second encryption stage, the metadata describing information on the encryption executed to the previous stage, the final encryption contents encrypted together with contents, and the final metadata describing information on the encryption executed in the current stage (the final encryption stage) are obtained.

Therefore, on receiving the multi-encrypted contents (final encryption contents and final metadata), the receiver can acquire the original contents by reversely performing the encryption stage as if peeling an onion.

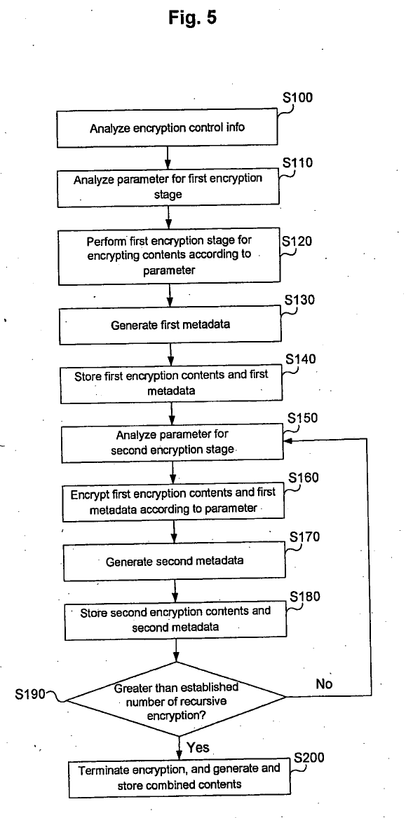

FIG. 5 shows a contents encryption process for performing the recursive encryption according to the embodiment of the present invention.

As shown in FIG. 5, the service manager 160 analyzes established encryption control information, and operates the contents multi-encryption module 132 and the metadata generation module 133 to perform encryption in step S100.

Encryption control information includes all pieces of control information for encryption according to the embodiment, and in particular, it includes control information for respective stages for recursive encryption. In detail, it includes a first encryption scheme to be used in the first encryption stage, corresponding encryption parameters, second encryption schemes to be respectively used in the second encryption stages, and corresponding encryption parameters. For example, encryption control information can be given as Table 1.

TABLE 1

| | | Encryption | Encryption |
|---|---|---|---|
| | | Scheme | Parameters |
| First Encryption Stage | | First Encryption | First Encryption |
| | | Scheme | Parameters |
| Second | (2-1)th | Second | Second |
| Encryption | Encryption Stage | Encryption | Encryption |
| Stage | | Scheme | Parameters |
| | (2-2)th | Third Encryption | Third Encryption |
| | Encryption Stage | Scheme | Parameters |
| | . | . | . |
| | . | . | . |
| | . | . | . |
| | (2-N)th | (2-N + 1)th | (2-N + 1)th |
| | Encryption Stage | Encryption | Encryption |
| | | Scheme | Parameters |

The encryption control information may be established by a manager through the manager interface 170 or may be automatically established by a program.

The encryption parameter represents a condition used for decrypting or encrypting contents by using a used encryption scheme (or an algorithm). For example, the encryption parameter may include a key value, a key length, an encryption format, an initialization vector value, an operation mode (mode information for combining encrypted data blocks), a padding type, a start position of contents to which encryption is applied, and a final position of the contents to which encryption is applied. The type of the encryption parameter is variable according to the used encryption scheme (algorithm).

One of the data encryption standards (DES) based on a symmetric key or an asymmetric key for encryption bit stream data, the Triple-DES, the Revest-Shamir-Adleman (RSA), the Advanced Encryption Standard (AES), the Digital Signature Standard (DSS), the MD5, the SHA, elliptic curve encryption, and a scheme for modifying the original data by using a symmetric encryption scheme or an asymmetric encryption scheme including encryption based on prime factorization can be used to the encryption scheme (or named as an encryption tool), and other encryption schemes can also be used.

The first encryption stage is performed according to the analysis result of encryption control information.

In detail, the contents multi-encryption module 132 analyzes the first encryption parameter established in the first encryption stage, and performs contents encryption by using the first encryption scheme based on the analysis result in step S110. In particular, when a partial encryption is established by the encryption parameter, the contents multi-encryption module 132 of the contents encryptor 130 according to the embodiment of the present invention extracts a portion that corresponds to a predetermined area from the contents that are withdrawn and provided by the contents withdrawal module 131 from the contents storage unit 110, that is, the contents to be encrypted, and encrypts the extracted portion according to the established encryption scheme in step S120, and transmits information including the executed encryption scheme and the position value of the area of the encrypted contents to the metadata generation module 133.

The metadata generation module 133 generates metadata based on the transmitted information, and in particular, it generates metadata including at least one of a used encryption scheme, a value of the used encryption parameter, an operation mode, a data padding scheme, information on the encrypted contents area in the contents, and decryption information (e.g., a key and a key length) used for decrypting the used encryption in step S130.

Different encryption schemes can be applied to a single piece of contents. That is, encryption can be performed by different encryption schemes to the respective areas that configure the contents, and in this case, the metadata generation module 133 can generate metadata to which an encryption scheme and decryption information are differently assigned for each area for each piece of contents.

When a single piece of contents is totally encrypted according to an encryption parameter, the contents multi-encryption module 132 encrypts the total contents according to a single established method, and the metadata generation module 133 generates metadata including at least one of a used encryption scheme, a value of the used encryption parameter, an operation mode, a data padding scheme, and decryption information used for decrypting the used encryption.

The contents encrypted in the first encryption stage are called “first encryption contents,” and the generated metadata are called “first metadata.” The first metadata generated as described above are stored and managed corresponding to the contents in step S140.

When the first encryption stage is performed, the second encryption stage is performed at least once according to the number of recursive encryptions established in the encryption control information.

When the second encryption stage is performed, by the control of the service manager 160, the contents multi-encryption module 132 encrypts encrypted results (which are first encryption contents acquired in the first encryption stage, and which can also be results acquired in a previously-performed second encryption stage from among the second encryption stages that are to be performed many times) acquired from the previous encryption stage (which is the first encryption stage, and which can also be a previously-performed second encryption stage from among the second encryption stages that are to be performed many times) together with corresponding metadata. For example, a second encryption parameter corresponding to the (2-1)th encryption stage is analyzed from among the encryption control information, and the first encryption contents that are the results of the first encryption stage and the first metadata are encrypted by using the second encryption scheme based on the analysis result in steps S150 and S160. In the below, the results acquired by encrypting the encrypted contents and the metadata will be referred to as “second encryption contents,” and the second encryption contents are acquired each time the second encryption stage is executed. Partial encryption can also be performed in the second encryption stage.

Next, the metadata generation module 133 generates metadata based oh the information transmitted from the contents multi-encryption module 132 according to the execution of the second encryption stage in step S170. Hereinafter, the metadata generated in the second encryption stage will be referred to as “second metadata.” In particular, the second metadata include a list of encryption schemes (encryption tools) applied in the encryption stages executed up to the current stage, an order of applied encryption schemes, and a list of encryption scheme substitutes.

The second metadata are stored and managed corresponding to the respective contents in step S180. Therefore, the metadata generation module 133 stores first metadata and at least one piece of second metadata corresponding to the IDs assigned to the original contents.

When the second encryption stage is performed as described above, the contents encryptor 9130 checks whether to re-execute the second encryption stage according to the number of recursive encryptions of encryption control information in step S190. The encryption process is terminated in step S200 when the second encryption stage is performed by as many as the number of recursive encryptions, and it returns to the previous step S150 to re-execute the second encryption stages S150 to S190 if else.

Therefore, the contents to be transmitted together with the metadata are multi-encrypted according to the number of recursive encryptions, as exemplified in FIG. 4.

When the second encryption stage is performed according to the established number of recursive encryptions, the combined contents generation module 134 sets the second encryption contents (results generated by encrypting the encryption results acquired in the previous stage and the corresponding metadata) which are results acquired in the final second encryption stage (e.g., the (2-N)th encryption stage when N=1, 2, 3, . . . ) to be final encryption contents, sets the second metadata that has information on the generation of the final second encryption contents, and combines the final encryption contents and the final metadata to generate combined contents. The combined contents are then transmitted to the user terminal. In this instance, the combined contents are generated for ease of managing the contents and data, and without being restricted to this, the final encryption contents and the final metadata can be individually stored and managed without combination thereof, and predetermined encryption contents and metadata can be transmitted to the user terminal according to a user request.

A structure of metadata according to the embodiment of the present invention, that is, second metadata performed by recursive encryption will now be described.

According to the embodiment of the present invention, as described above, multiple encryption contents are acquired when the first and second encryption stages are performed, and in particular, the second encryption stage is performed at least once. Therefore, when decrypting the multiple encryption contents (final encryption contents), the receiver must reversely perform the encryption stage as if peeling an onion layer by layer. Hence, the final metadata provided to the user terminal must include information for showing what type of encryption scheme is used and in what method the encryption method is applied until the final encryption contents are generated. Therefore, in the embodiment of the present invention, a list of encryption tools (encryption schemes) to which the encryption metadata are used, parameter information on the respective encryption tools, a list of applying the encryption tools, and a list of encryption tool substitutes are included.

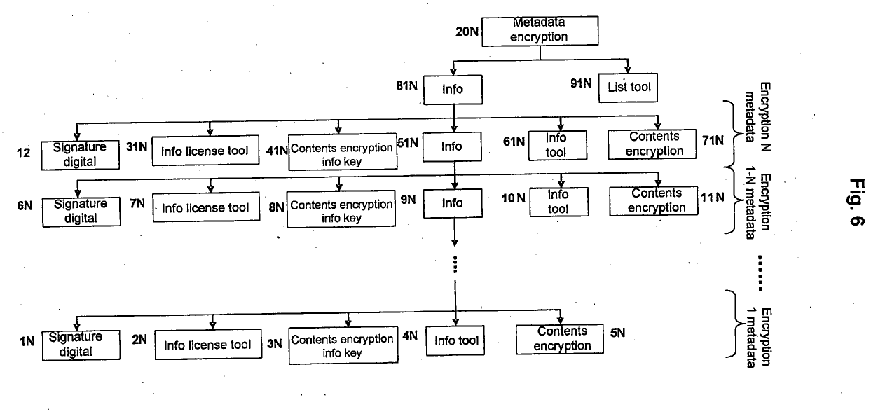

FIG. 6 shows a structure of encryption metadata according to an embodiment of the present invention.

In order to efficiently decrypt the contents which are encrypted in many folds in the recursive structure on the user terminal, the encryption metadata has a tree structure, as shown in FIG. 6, including parameter information on the respective encryption tools applied for protecting multiple contents, an order for applying the respective encryption tools, positions of the encryption tools, and a list of encryption tool substitutes. In addition, the encryption metadata describe digital signature information on the contents protection metadata, binary encryption tools, and contents copyright information in the tree-structured recursive method.

In particular, FIG. 6 shows an example of a digital rights management (DRM) description structure. The DRM is server software developed for guaranteeing secure distribution of paid contents through the web, and preventing illegal distribution which is more important. The DRM completely supports tasks from contents generation to distribution and management, including securely protecting the rights and benefits of contents providers, preventing illegal reproduction, billing usage fees, and functioning as agents for settlement.

Also, the encryption metadata has a structure for protecting at least one partial node, and has a structure for providing encryption tool information of the protected node as metadata.

In detail, referring to FIG. 6, the encryption metadata according to the embodiment of the present invention has a tree structure, and includes a plurality of nodes (e.g., encryption contents, tool information, encryption contents key information, tool license information, and digital signature.) Each node has information on the encrypted contents, and in particular, the “encryption contents key information” node from among the nodes is very sensitive and important information having a key for solving encryption contents, and the metadata of the node can be partially encrypted. That is, the “encryption contents key information” node can be selected and encrypted without totally encrypting the tree-structured encryption metadata. In this instance, for example, in order to more efficiently encrypt the encryption metadata, metadata of the “tool information” node for indicating a tool list and the “encryption contents key information” node can be encrypted.

When the encryption metadata acquired in the respective encryption stages are sequentially positioned from the bottom layer, the first encryption metadata acquired in the first encryption stage are positioned in the lowest layer (N1, N2, N3, N4, and N5 nodes), and the second encryption metadata are positioned on the top side of the lowest layer for example, and in a similar manner, the (N−1)th encryption data are positioned in the (N−1)th encryption layers (N6, N7, NB, N9, N10, and N11), and the Nth encryption data are positioned in the Nth encryption layers (N12, N13, N14, N15, N16, and N17), and thus the encryption metadata are totally configured in the bottom-up form.

Since the encryption metadata are configured in the above-noted structure, reverse encryption is performed sequentially in the top-down direction from the Nth encryption layer acquired by the most recent encryption, and the reverse encryption can be performed to the lowest (first encryption) layer including the metadata to which the initial encryption is performed. That is, the encryption metadata are reversely encrypted in a like manner of peeling the layers of an onion from the outside thereof.

Since the encryption metadata have a tool list node N19 including the tool list used for performance of encryption below the uppermost node N20, a decryption tool used for solving the encryption contents to be decrypted can be instantly prepared for the application only when the used tool list node N19 is analyzed. The nodes are then parsed in the top-down direction of N18→N15→N9 . . . starting from the next “information” node N15. The bottom encryption layer is the first encryption layer to which the encryption is initially applied, and hence it has no “information” node.

Since the encryption metadata according to the embodiment of the present invention have a systematic structure, the contents which are encrypted in many folds in the recursive structure can be efficiently decrypted by using the encryption metadata.

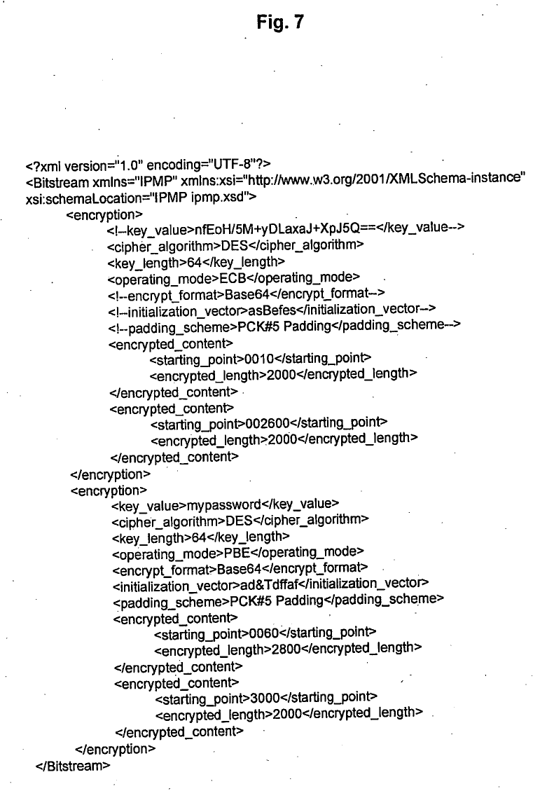

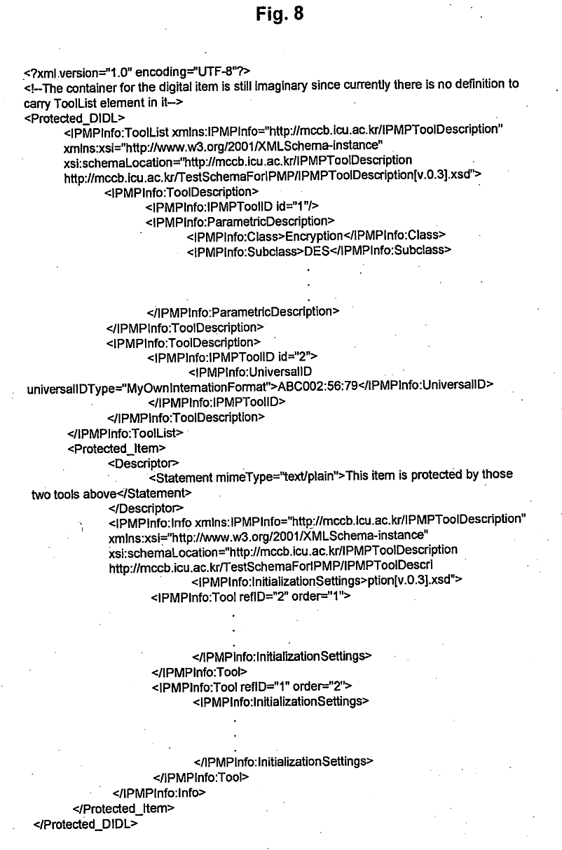

FIG. 7 and FIG. 8 show exemplified encryption metadata according to the embodiment of the present invention.

In FIG. 7, the DES is used as an encryption algorithm, the key value for solving the encryption is given as “nfEoH/5M+yDLaxaJ+XpJ5Q==”, the key length is given as 64 bits, the operational mode of the DES algorithm applied for encryption is given as an “ECB”, the used padding scheme is “PCK#5”, and the initial vector value is given as “asBefes”.

FIG. 8 shows metadata for showing information on how the encryption tool is applied to a single piece of contents. In FIG. 8, the applied encryption tool can be known by the first indicator that is the <IPMPInfo:IPMPToolID> tag, and an application order of the encryption tool applied by the second indicator that is the <IPMPInfo:Tool> tag. That is, in FIG. 8, the <IPMPInfo:Tool refID=“2” order=“1”> represents that the encryption tool with the reference ID of 2 is used in the first order (order=“1”). In the case of applying the encryption tool with the reference ID of 2, the metadata for the encryption parameter are positioned within the <IPMPInfo:InitializationSrttings> tag as shown in FIG. 7.

Next, a method for providing recursively encrypted contents through the network will be described.

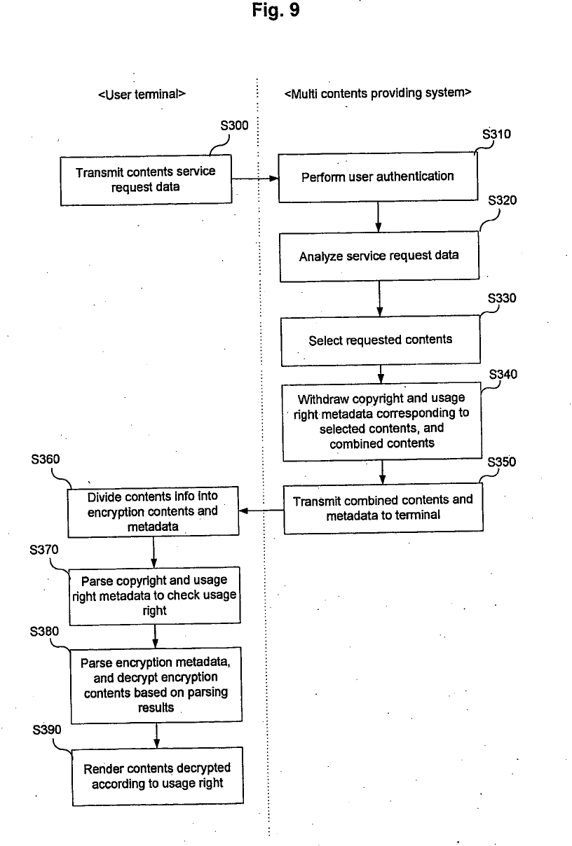

FIG. 9 shows a flowchart of a method for providing contents according to an embodiment of the present invention.

It will be described that the contents are provided with the precondition that the contents (in particular, recursively encrypted contents) according to the embodiment of the present invention are encrypted in the multiple manner, the multi-encrypted contents and corresponding encryption metadata are generated and stored as combined contents, and the contents rights metadata are generated and stored. Without being restricted to this description, the process for encrypting the contents and generating the metadata according to the user's contents request can be performed, and the contents based on the process can then be provided.

As shown in FIG. 9, when the user requests to receive predetermined contents through the interface 31 by using the terminal 300, the user terminal manager 32 generates contents service request data according to the request, and transmits the same to the system 100 in step S300. In this instance, the contents service request data includes at least one of a display size of the terminal, a color depth, features of an encoder and a decoder, a battery lifespan, an operating system, program execution environments, and an encryption contents decryptor (encryption contents reverse encryption processing module.)

On receiving the contents service request data through the network 200, the authenticator 150 of the system 100 checks whether the user can receive the contents. For example, when the user inputs an ID and a password according to the request by the authenticator 150, the authenticator 150 authenticates the user in step S310 based on the information on whether the input ID and the password are stored in the user database 151 and whether the input ID and the password match the stored ones in step S310.

When the user of the terminal 300 having provided the request data is authenticated to be a legal user who can receive contents, the authenticator 150 transmits authentication results to the user terminal 300, and the contents processor 120 and the contents encryptor 130 process the requested contents and transmit the same to the transmitter 140.

In detail, the service manager 160 analyzes the contents service request data transmitted through the network 200 to check which contents are requested by the user, and transmits checking results to the contents encryptor 130 and the contents processor 120.

The contents encryptor 130 withdraws the combined contents generated by multi-encrypting the contents requested from the combined contents storage module 135 and combining the multi-encrypted contents and corresponding metadata, and transmits the combined contents to the transmitter 140. The withdrawn combined contents are generated by combining the final encryption contents that are multi-encrypted according to the established recursive number and the final metadata.

Also, a copyright and usage right metadata withdrawal module 136 withdraws metadata on the copyright and the usage right established on the combined contents, and transmits the same to the transmitter 140 in steps S330 and S340.

Next, the contents transmitter 140 encodes (modulates) the combined contents and the copyright and usage right metadata according to a transmission format, and transmits them to the user terminal through the network 200 in step S350. In this instance, in order to efficiently process the contents, the contents transmitter 140 considers at least one of a display size of the terminal that processes contents information according to the contents service request data, a color depth, features of an encoder and a decoder, a battery lifespan, an operating system, program execution environments, and an encryption contents decryptor; acquires appropriate combined contents, a copyright, and usage right metadata from the contents encryptor 130; processes the data; and transmits processed results to the user terminal 300. For ease of description, the modulated and transmitted combined contents and usage right metadata will be referred to as “contents information.”

In response to this, the encryption contents and metadata receiver 33 of the user terminal 300 decodes (reversely modulates) the transmitted contents information to divide them into encryption contents, encryption metadata, and copyright and usage right metadata, and inputs the divided data to the contents decryptor 35 and the metadata parsing and rendering controller 34 in step S360.

The metadata parsing and rendering controller 34 parses the copyright and usage right metadata to check the user's contents copyright and usage right in step S370. The copyright and usage right metadata may include contents usage conditions such as a time, a date, a designated terminal, a designated user, a number of reproductions, and designated contents, and may also include a usage right following contents usage combination, that is, a usage right following usage order. Therefore, the metadata parsing and rendering controller 34 parses the encryption metadata and transmits parsing results to the content decryptor 35 when the usage right is assigned to the user (or user terminal) after checking them.

The content decryptor 35 uses the input encryption metadata to decrypt the encryption contents transmitted by the metadata parsing and rendering controller 34, and transmits parsing results to the contents renderer 36 in steps S380 and S390.

In the embodiment, the contents encryptor 130 can partially encrypt the contents instead of encrypting the total contents in the first and second encryption stages. That is, when partial encryption is established by the encryption parameter, the contents multi-encryption module 132 extracts a predetermined area from the contents to be encrypted according to the established encryption scheme to encrypt the extracted area according to the established encryption scheme. Encryption metadata are generated based on the information including the executed encryption scheme and the position value on the area of the encrypted contents, and in particular, the encryption metadata include information on the encrypted contents area in the contents. The above-noted partial encryption can reduce the processing time used for contents encryption, and also can reduce the time used for decoding (decryption) at the user terminal.

Also, the contents encryptor 130 can apply different encryption schemes to a single piece of contents. That is, the contents encryptor 130 can apply different encryption schemes to respective areas forming the contents to perform encryption, and the encryption metadata generated in this case have different encryption schemes and decryption information for the respective areas in the single piece of contents.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

For example, the above-described encryption process and contents providing method can be realized as a program to be stored in a recording medium readable by a computer. The recording medium may include all types of recording devices for storing data readable by the computer, such as a CD-ROM, a magnetic tape, a floppy disk, and a carrier wave format (transmission through the Internet.)

1. A method for encrypting contents, comprising:
encrypting the contents according to a first encryption scheme, and generating first encryption metadata including information on the performance of encrypting to thus perform a first encryption stage;
encrypting the contents that are encrypted in the previous stage and corresponding metadata according to an established encryption scheme, and generating second encryption metadata including information on the performance of encrypting to thus perform a second encryption stage; and
performing the second encryption stage as many as the established number of times and generating final encryption contents and final encryption metadata to thus perform a final stage.

2. The method of claim 1, wherein the final encryption contents are generated by encrypting encryption metadata describing information on encryption executed before the final stage and the contents, and the final encryption metadata include information on the encryption executed in the final stage.

3. The method of claim 1 wherein the encryption metadata include at least one of parameter information on respective encryption tools, an order of the applied encryption tools, positions of the encryption tools, and a list of encryption tool substitutes.

4. The method of claim 3, wherein the encryption metadata have nodes in a tree structure, and the nodes include encryption information.

5. The method of claim 1, wherein the first encryption stage or the second encryption stage partially performs encryption on the contents.

6. The method of claim 1, wherein the encryption metadata according to the encryption include information on the encrypted area of the contents.

7. The method of claim 1, wherein the first encryption stage or the second encryption stage performs encryption by applying different encryption schemes to the respective areas forming the contents, and the encryption metadata generated by the encryption have different encryption schemes and decryption information for the respective areas of the contents.

8. A recording medium for recording a program executed on a computer following one of methods disclosed in claim 1 to claim 7.

9. A system for providing contents to a user terminal, comprising:
a contents encryptor for encrypting, storing, and managing contents, and generating, storing, and managing encryption metadata according to the encryption;
a user interface for receiving contents service request data from the user terminal; and
a contents transmitter for processing the encrypted contents that are provided by the contents encryptor and correspond to the contents service request data, and encryption metadata corresponding to the contents into transmittable contents information, and transmitting the contents information to the user terminal,
wherein the contents encryptor encrypts the contents according to an established first encryption scheme, performs a first encryption stage for generating first encryption metadata including information on the performance of execution, encrypts the contents encrypted in the previous stage and corresponding metadata according to an established number of encryptions, and performs a second encryption stage for generating second encryption metadata including information on the performance of the encryption at least once.

10. The system of claim 9, wherein the contents encryptor comprises:
a contents multi-encryption module for performing the first encryption stage and the second encryption stage to encrypt the contents in a multiple manner;
a metadata generation module for generating encryption information used in the contents multi-encryption into encryption metadata;
a combined contents generation module for combining the multi-encrypted contents and encryption metadata into a single unit of combined contents; and
a combined contents storage module for storing and managing the combined contents.

11. The system of claim 9 or 10, wherein the system further comprises a contents processor for generating, storing, and managing metadata that indicate copyright and usage right information on the contents, and the contents transmitter processes the combined contents generated by combining the encrypted contents and encryption metadata related to the contents, as well as the metadata provided by the contents processor, into transmittable contents information, and transmits the contents information to the user terminal.

12. The system of claim 11, wherein the user terminal comprises:
a user interface;
a user terminal manager for generating contents service request data according to a user request input through the user interface, and transmitting the contents service request data to the system;
an encryption contents and metadata receiver for receiving contents information from the system, and dividing the contents information into encrypted contents, encryption metadata, and metadata;
a metadata parsing and rendering controller for parsing the metadata to check the usage right on the contents, and parsing the encryption metadata when the contents are available;
an encryption contents decryptor for decrypting the encrypted contents based on the parsing results of the encryption metadata; and
a contents renderer for processing the decrypted contents.

13. The system of claim 12, wherein the contents service request data comprise at least one of a terminal display size, a color depth, features of an encoder and a decoder, a battery lifespan, an operating system, program execution environments, and an encryption contents decryptor (encryption contents reverse encryption processing module.)

14. The system of claim 13, wherein the contents transmitter considers at least one of a terminal display size, a color depth, features of an encoder and a decoder, a battery lifespan, an operating system, program execution environments, and an encryption contents decryptor (encryption contents reverse encryption processing module) based on the contents service request data, receives and processes encrypted contents and encryption metadata related to the contents from the contents encryptor, receives and processes metadata from the contents processor, and transmits processing results to the user terminal.

15. The system of claim 11, wherein the contents encryptor performs encryption on a predetermined area of the contents in the first encryption stage or the second encryption stage, and in this instance, the encryption metadata include information on the encrypted contents area within the contents.

16. A method for providing contents in a system for providing contents to a user terminal, the method comprising:
a) the system encrypting the contents, generating encryption metadata based on encryption information used for the encryption, and combining the encrypted contents and the encryption metadata to generate combined contents;
b) the system generating copyright metadata based on copyright and usage right information on the contents;
c) the system selecting corresponding combined contents according to contents service request data transmitted by the user terminal;
d) the system acquiring the selected combined contents and copyright metadata; and
e) the system processing the combined contents and metadata to be transmittable contents information, and transmitting the contents information to the user terminal,
wherein a) comprises encrypting the contents according to an established first encryption scheme, performing a first encryption stage for generating first encryption metadata including information on the performance of the encryption, encrypting the contents encrypted in the previous stage and corresponding metadata according to an established second encryption scheme according to an established number of encryptions, and performing a second encryption stage for generating second encryption metadata including information on the performance of the encryption, at least once.

17. The method of claim 16, wherein a) comprises performing encryption by applying different encryption schemes to the respective areas forming the contents, and the first metadata have different encryption schemes and decoding information for the respective areas for a single piece of contents.

18. The method of claim 16, wherein the encryption metadata include at least one of parameter information for respective encryption tools, an order of the applied encryption tools, positions of the encryption tools, and a list of encryption tool substitutes.

19. The method of claim 16, wherein c) comprises performing user authentication on the user terminal having transmitted the contents service request data, and selecting corresponding combined contents when the user is an authenticated user.
